(19) United States
(12) Patent Application Publication
(10) Pub. No.: US 2026/0359606 A1
(43) Pub. Date: Nov. 12, 2026

(54) AI-POWERED SYSTEM AND METHOD FOR PATH COMPUTATION AND SERVICE PLANNING IN CONNECTION-ORIENTED COMMUNICATION NETWORKS

(71) Applicant: Huawei Technologies Co., Ltd., Shenzhen (CN)

(72) Inventor: Mahdi Hemmati, Ottawa (CA)

(21) Appl. No.: 19/205,641

(22) Filed: May 12, 2025

(51) Int. Cl. G06N 3/0455; G06N 3/0895; G06N 3/092; H04L 45/02

(52) U.S. Cl. CPC G06N 3/0455; G06N 3/0895; G06N 3/092; H04L 45/08

(57) ABSTRACT

A method and system for improving computational efficiency and solution quality of network routing/planning in an optical network by using an AI architecture to autoregressively construct paths for service requests. The AI architecture comprises an encoder neural network and a decoder neural network. The encoder neural network may take, as input, a network topology or an optical network and generate embedding vectors that capture the network topology. The encoder neural network may be a graph neural network. The decoder neural network may then, in turn, autoregressively construct paths/lightpaths for service requests relating to the optical network. The autoregressive construction of the paths/lightpaths may further be based on a dynamic network state that reflects available capacities of links in the optical network. The AI architecture, or components thereof, may be trained by reinforcement learning.

### TECHNICAL FIELD

The present disclosure relates to an optical transport network, and a machine-learning enabled method and apparatus for planning and provisioning an optical transport network.

### BACKGROUND

Optical network and service planning is a critical problem that underpins the efficiency, scalability, and reliability of modern telecommunications infrastructure. In wavelength-division multiplexing (WDM) networks, the planning problem involves determining optimal routes and wavelengths for lightpaths (end-to-end optical connections). The objective of this routing and wavelength assignment (RWA) problem is to minimize blocking probability, maximize spectral efficiency, and balance loads across the network, all while managing physical-layer impairments and satisfying wavelength continuity and non-conflicting constraints.

In optical transport networks (OTNs), service planning involves traffic grooming and routing problems. Traffic grooming focuses on mapping client services (e.g., Ethernet, IP) onto optical channel data unit (ODU) containers while optimizing resource utilization. In OTN routing, the goal is to compute optical paths for client service requests and assign corresponding ODU timeslots on OTN links (established lightpaths) while respecting capacity constraints and meeting service level agreements (SLAs).

These planning and service provisioning problems are NP-hard combinatorial optimizations, requiring complex trade-offs, while their search space grows exponentially with the network size. For large-scale network topologies, even the most powerful state-of-the-art optimization solvers are not able to find the optimal planning solution. Dynamic traffic patterns, heterogeneous service demands, and multi-layer coordination further complicate planning, necessitating advanced algorithms to achieve scalable, cost-effective and future-proof solutions.

### SUMMARY

The present application proposes techniques that facilitate improving computational efficiency of network routing/planning/restoration in an optical network by using an AI architecture to autoregressively construct paths for service requests. The AI architecture comprises an encoder neural network and a decoder neural network. The encoder neural network may take, as input, a network topology or an optical network and generate embedding vectors that capture the network topology. The encoder neural network may be a graph neural network. The decoder neural network may then, in turn, autoregressively construct paths/lightpaths for service requests relating to the optical network. The autoregressive construction of the paths/lightpaths may further be based on a dynamic network state that reflects available capacities of links in the optical network.

In an aspect of the present disclosure, there is provided a computer-implemented method for optical network routing. The method comprises encoding a network topology of the optical network using an encoder neural network. The encoder neural network encodes a plurality of nodes and a plurality of edges connecting pairs of the plurality of nodes to generate a plurality of embedding vectors. The method further comprises obtaining one or more service requests. Each of the one or more service requests may be associated with a respective source node and a respective destination node. The plurality of nodes includes the respective source node and the respective destination node. The method further comprises constructing, for each of the one or more service requests, a respective path in the network topology from the respective source node to the respective destination node using a decoder neural network. The constructing comprises inputting the plurality of embedding vectors and the one or more service requests to the decoder neural network. The constructing further comprises, for each of the respective paths, starting from the respective source node, iteratively and autoregressively determining a next node on the respective path based on a dynamic network state. The method further comprises instructing one or more of a plurality of optical nodes corresponding to the plurality of nodes and one or more of a plurality of links corresponding to the plurality of edges to allocate resources to establish, for each of the respective paths, corresponding service paths in the optical network.

In some implementations, the decoder neural network is configured to generate a probability distribution over the plurality of nodes and the next node corresponds to a greatest probability in the probability distribution.

In some implementations, the decoder neural network is configured to, for each of the respective paths, starting from the respective source node, iteratively and autoregressively 1) generate a probability distribution for determining the next node on the respective path based on the dynamic network state, and 2) determine, based on the probability distribution, a sample of one or more of the plurality of nodes. The method may further comprise constructing each of the respective paths based on the samples of the one or more of the plurality of nodes.

In some implementations, one of the one or more service requests is associated with a respective bandwidth, each of the plurality of edges is associated with a respective capacity, and the dynamic network state indicates, based at least on the respective capacities of the plurality of edges, available capacities in the network topology. The method further comprises, in response to autoregressively determining a next node on the respective path of the one of the one or more service requests, and prior to another iteration of the autoregressive determining, updating the dynamic network state based on the respective bandwidth.

In some implementations, the method further comprises 1) maintaining, subsequent to determining the respective path of the one of the one or more service requests, the dynamic network state, and 2) constructing, using the dynamic network state, the respective path of another one of the one or more service requests.

In some implementations, each of the plurality of edges is associated with one or more respective wavelengths and the method further comprises using the decoder neural network to determine, along with the next node, an assignment of one of the one or more respective wavelengths associated with an edge connecting the next node to a previous node on the respective path.

In some implementations, each of the plurality of edges is associated with a respective available spectrum and the method further comprises using the decoder neural network to determine, along with the next node, an assignment of a segment of the respective available spectrum associated with an edge connecting the next node to a previous node on the respective path.

In some implementations, prior to encoding the network topology, the encoder neural network is trained via self-supervised learning.

In some implementations, the encoder neural network and the decoder neural network are trained via reinforcement learning. The training includes obtaining a sample network topology and a sample service request, the sample service request being associated with a sample source node in the sample network topology and a sample destination node in the network topology. The training further includes masking, with respect to the sample network topology, invalid node selections. The training further includes enabling the decoder neural network to, given a sample partially constructed path, select a sample next node in the network topology, the sample next node being connected to the sample partially constructed path via a sample edge of the network topology and not being in the sample partially constructed path. The training further includes generating a sample constructed path based on the sample service request. Further, a reward signal is generated based on the sample constructed path.

In some implementations, the reward signal is configured to be in response to the sample constructed path succeeding at reaching from the sample source node to the sample destination node, a negative value representing a measure of sample resources used in the sample network topology by establishing a corresponding sample service path from the sample source node to the sample destination node. The reward signal is also configured to be in response to the sample constructed path failing at reaching from the sample source node to the sample destination node, a penalty with fixed negative value.

In some implementations, a network failure is detected in the optical network. Further, at least one of the one or more service requests is obtained in response to detecting the network failure.

According to another aspect of the present disclosure, there is provided a computer readable storage medium, comprising one or more instructions, wherein when the one or more instructions are run on a computer, the computer performs any of the methods disclosed herein.

According to another aspect of the present disclosure, there is provided a non-transitory computer-readable medium storing instruction the instructions causing at least one processor in at least one device to implement any of the methods disclosed herein.

According to another aspect of the present disclosure, there is provided at least one device configured to perform any of the methods disclosed herein.

According to another aspect of the present disclosure, there is provided at least one processor, configured to execute instructions to cause at least one device to perform any of the methods disclosed herein.

According to another aspect of the present disclosure, there is provided an integrated circuit configure to perform any of the methods disclosed herein.

According to another aspect of the present disclosure, there is provided a module comprising: one or more circuits for performing any of the methods disclosed herein.

According to another aspect of the present disclosure, there is provided an apparatus comprising: one or more processors functionally connected to one or more memories for performing any of the methods disclosed herein.

According to another aspect of the present disclosure, there is provided an apparatus configured to perform any of the methods disclosed herein.

In some embodiments, the apparatus comprises one or more units configured to perform the above-described method.

According to another aspect of the present disclosure, there is provided one or more non-transitory, computer-readable storage media comprising computer-executable instructions, wherein the instructions, when executed, cause at least one processing unit, at least one processor, or at least one circuits to perform any of the methods disclosed herein.

According to another aspect of the present disclosure, there is provided one or more computer-readable storage media storing a computer program, wherein, when the computer program is executed by an apparatus, the apparatus is enabled to implement any of the methods disclosed herein.

According to another aspect of the present disclosure, there is provided a computer program product including one or more instructions, wherein, when the instructions are executed by an apparatus, the apparatus is enabled to implement any of the methods disclosed herein.

According to another aspect of the present disclosure, there is provided a computer program, wherein, when the computer program is executed by a computer, an apparatus is enabled to implement any of the methods disclosed herein.

According to another aspect of the present disclosure, there is provided a system comprising a node for performing any of the methods disclosed herein.

### BRIEF DESCRIPTION OF THE DRAWINGS

Embodiments are described in detail below, with reference to the following drawings:

FIG. 1 is a simplified diagram of elements of an example optical network;

FIG. 2 is a simplified diagram illustrating an artificial intelligence (AI) architecture for routing service requests in an optical network;

FIG. 3 is a simplified diagram illustrating an implementation of the AI architecture of FIG. 2;

FIG. 4 is a process flow diagram illustrating interactions of data/embeddings in an embodiment of an AI architecture for routing service requests in an optical network;

FIG. 5 is another process flow diagram illustrating interactions of data/embeddings in another embodiment of an AI architecture for routing service requests in an optical network;

FIG. 6 illustrates an example computing system in accordance with example embodiments;

FIG. 7 illustrates, in flowchart form, a method for routing service requests in an optical network using an AI architecture;

FIG. 8 illustrates, in flowchart form, a method for routing service requests in response to detecting a network condition in an optical network;

FIG. 9 illustrates, in flowchart form, a method for iteratively and autoregressively constructing a path in an optical network; and

FIG. 10 illustrates, in flowchart form, a method for training, via reinforcement learning, an AI architecture for routing service requests in an optical network.

Like reference numerals are used in the drawings to denote like elements and features.

### DETAILED DESCRIPTION OF EMBODIMENTS

Embodiments disclosed herein relate to systems and apparatuses using AI and neural networks. The systems and apparatuses disclosed herein may comprise suitable modules and/or circuitries for executing various procedures.

As those skilled in the art understand, a “module” is a term of explanation referring to a hardware structure such as a circuitry implemented using technologies such as electrical and/or optical technologies (and with more specific examples of semiconductors) for performing defined operations or processing. A “module” may alternatively refer to the combination of a hardware structure and a software structure, wherein the hardware structure may be implemented using technologies such as electrical and/or optical technologies (and with more specific examples of semiconductors) in a general manner for performing defined operations or processing according to the software structure in the form of a set of instructions stored in one or more non-transitory, computer-readable storage devices or media.

A module may be a part of a device, an apparatus, a system, and/or the like, wherein the module may be coupled to or integrated with other parts of the device, apparatus, or system such that the combination thereof forms the device, apparatus, or system. Alternatively, the module may be implemented as a standalone device or apparatus.

The module usually executes a procedure for performing a method. Herein, a procedure has a general meaning equivalent to that of a method. More specifically, a procedure is a defined method implemented using hardware components for processing data. A procedure may comprise or use one or more functions for processing data as designed. Herein, a function is a defined sub-procedure or sub-method for computing, calculating, or otherwise processing input data in a defined manner and generating or otherwise producing output data.

As those skilled in the art will appreciate, a procedure may be implemented as one or more software and/or firmware programs having necessary computer-executable code or instructions and stored in one or more non-transitory computer-readable storage devices or media which may be any volatile and/or non-volatile, non-removable or removable storage devices such as RAM, ROM, EEPROM, solid-state memory devices, hard disks, CDs, DVDs, flash memory devices, and/or the like. A module may read the computer-executable code from the storage devices and execute the computer-executable code to perform the procedure.

Alternatively, a procedure may be implemented as one or more hardware structures having necessary electrical and/or optical components, circuits, logic gates, integrated circuit (IC) chips, and/or the like.

### Optical Networks and Optical Transport Networks (OTNs)

To assist in understanding the present disclosure, some concepts relevant to Optical networks and OTNs are first discussed.

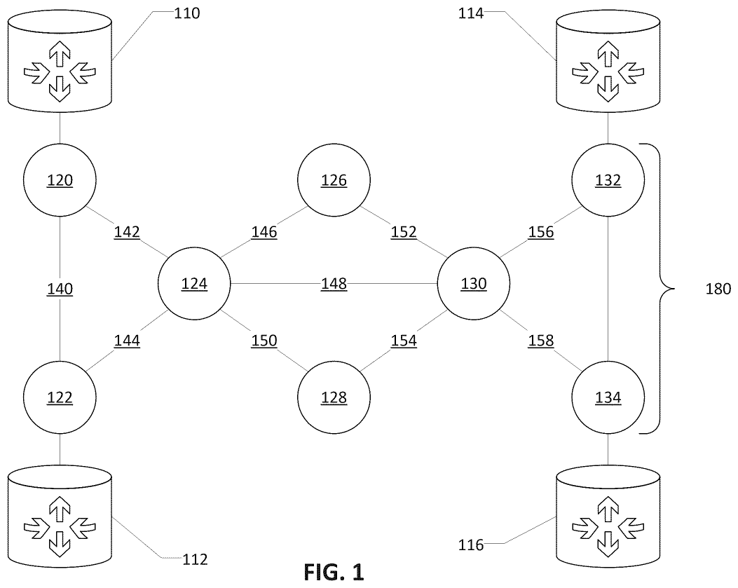

An optical network is a communication network that uses optical signals to transmit data. The optical signals are often transmitted between nodes via optical fiber connections. FIG. 1 illustrates elements of such an example optical network. FIG. 1 shows stations 110-116 and an optical network 180, the optical network 180 includes nodes 120-134 and edges 140-158. The stations 110-116 (depicted as routers) may act as sources and destinations of the information being transmitted and received over the optical network 180. That is, the stations 110-116 may transmit and/or receive information/data/content to and from each other. In some embodiments, the optical network 180 may provide service to upper layers of the Open Systems Interconnection (OSI) hierarchy. Specifically, the stations 110-116 may be Layer 3 routers and the optical network 180 may be responsible for Layer 1 and/or Layer 2 communication in the OSI hierarchy. A request from the stations 110-116 to transmit data to another one of the stations 110-116 may be considered a service request. For example, a request from the station 110 to transmit data (e.g. Layer 3 packets) to the station 116 may be considered a service request.

The nodes 120-134 may act as hubs for the edges 140-158. For example, as shown in FIG. 1, the node 124 acts as a hub for the edges 142, 144, 146, and 150. As shown in FIG. 1, the nodes 120-134 are operatively connected to each via the edges 140-158. That is, even if one of the nodes 120-134 is not directly connected to another one of the nodes 120-134 (the nodes 124 and 126 being an example of directly connected nodes via the edge 146), there may be a path in the optical network 180 that connects the nodes. For example, the nodes 120 and 134 are connected via a path formed by the edges 142, 148, and 158. It should be appreciated that in an optical network, optical signals are transmitted along paths in the optical network. Further, in some optical networks, the optical signals may be transmitted via a continuously available light wavelength/spectrum along a path in the optical network. Such a path with a wavelength/spectrum assignment may be called lightpath. For clarification, a path may be considered a series of nodes and/or connections/links/edges in an optical network. A lightpath, on the other hand, may be considered a path in an optical network with a wavelength/spectrum assignment. Throughout the specification, where applicable, the terms “path” and “lightpath” may be used interchangeably (where they are functionally interchangeable). It should also be noted that for the sake of generality, throughout the specification, the term “edges” is used to refer to links or connections in the optical network 180, optical networks in general, or a network topology of an optical network. Types of “edges” may be distinguishable from others depending on the context. For example, to the end of constructing a service path in an OTN, “edge” may refer or correspond to an established lightpath in an underlying wavelength division multiplexing (WDM) network used to implement the OTN. In another example, to the end of constructing a service path by solving the RWA problem or routing, modulation, and spectrum assignment (RMSA) problem, “edge” may refer to or correspond to fiber link connections in a physical topology of an optical network. It is further noted that throughout the specification, where applicable, the terms “edge,” “link,” and “connection” may be used interchangeably (where they are functionally interchangeable).

The stations 110-116 may be operatively connected to the optical network 180. To this end, FIG. 1 shows the stations 110, 112, 114, and 116 being respectively operatively connected to the nodes 120, 122, 132, and 134. These operative connections may be facilitated by, for example, an optical network terminal. In an example, the station 110 may be tasked with (e.g. as a result of a command from an end-user) transmitting data to the station 116. To this end, a connection between the stations 110 and 116 may be established in the optical network 180. In totality, this connection may comprise the operative connection between the station 110 and the node 120, the node 120, the edge 142, the node 124, the edge 148, the node 130, the edge 158, the node 134, and the operative connection between the node 134 and the station 116.

The structure of the optical network 180 as defined by nodes and their connections may be referred to as a topology or network topology.

In some implementations, the edges 140-158 may be optical fiber cables. Further each of the edges 140-158 may be associated with an attribute such as a capacity or bandwidth that define that amount of data (or data rate) that can be transmitted therethrough. Likewise, the nodes 120-134 may be associated with attributes.

The structure of the optical network 180 as defined by nodes and their edges may be referred to as a network topology. The network topology may further include attributes of the nodes 120-134 and attributes of the edges 140-158.

Further, in some embodiments, the optical network 180 may facilitate wavelength division multiplexing (WDM). WDM allows optical signals of different wavelengths to be simultaneously transmitted on the edges 140-158. WDM allows bidirectional communication between the nodes 120-134 as well as simultaneous transmissions of different signals within the same one of the edges 140-158. Additionally or alternatively, the optical network 180 may facilitate RMSA. RMSA may allow the network to employ different modulations to transmit different optical signals. Further, RMSA may involve more fine-grained spectrum assignment as opposed to a wavelength assignment. A spectrum may be considered a range of wavelengths. It should be appreciated that for RMSA, the assigned modulation and the assigned spectrum may not be independent (i.e., they are related). For example, the rate of the modulation assignment and the width of the spectrum assignment may be inversely related. Accordingly, RMSA, as well as WDM, may increase throughput of the optical network 180.

While not explicitly shown in FIG. 1, the optical network 180 may further comprise a centralized server or centralized controller. The centralized server or centralized controller may facilitate monitoring or managing of the optical network 180. Such monitoring and managing may include detecting failures in the optical network 180, monitoring health of the optical network 180, establishing optical paths in the optical network 180, and restoring paths or connections in the optical network 180. Going back to the example of transmitting data from the station 110 to the station 116, the centralized controller may detect that that the edge 148 is faulty (e.g. it is cut). In response thereto, the centralized controller may cause the optical network 180 to establish a new path to facilitate the transmitting of data from the station 110 to the station 116. This new path may comprise, for example, the edges 142, 150, 154, and 158 (instead of the original path comprising the edges 142, 148, and 158). In other embodiments, monitoring and managing of the optical network 180 may be implemented in a distributed manner. In such embodiments, network elements (NEs) of one or more of the nodes 120-134 may be used for distributed restoration path computation.

An OTN comprises a layered, standards-based optical network architecture designed to provide reliable, high-capacity transport of digital data over an optical network. The OTN enables efficient multiplexing, routing, switching, and management of various client signals oftentimes using WDM techniques, while ensuring end-to-end performance monitoring, fault isolation, and signal integrity across heterogeneous network elements. An OTN oftentimes operates in accordance with International Telecommunication Union (ITU) recommendations such as G.709 and G798.

In an OTN, data is encapsulated into containers known as optical data units (ODUs) or ODU containers which are in turn mapped to optical transport units (OTUs) for transmission along optical lines, cables, or connections such as the connections 140-158 of FIG. 1. ODUs may be referred to as ODUks or ODUk containers. The “k” in “ODUk” identifies a data transfer rate in the optical network. For example, ODU0 has a data transfer rate of 1.2 Gbits/s. In another example, ODU1 has a data transfer rate of 2.4 Gbits/s.

### Machine Learning (ML), Neural Networks, and Graph Neural Networks (GNN)s

To further assist in understanding the present disclosure, some concepts relevant to ML and neural network are discussed.

Generally, a neural network comprises a plurality of interconnected artificial neurons arranged in multiple layers, including an input layer, an output layer and, oftentimes, a hidden (intermediate) layer. The neural network is designed to process input data, extract relevant features, and generate an output based on learned patterns and correlations. An artificial neuron within the network is configured to receive one or more input signals, apply a weighted transformation to the inputs, and process the transformed data using an activation function. Output from one layer in the network may be forwarded (input) to a next layer in the network until a final output layer of the neural network. Some neural networks may have more complex mechanisms for inputting data from one layer to another than taking output from layer and providing the output to the next layer. For example, in some neural networks, a skip connection may be used to feed output of a first layer of a neural network to a second layer wherein the second layer is not the layer directly following the first layer. In another example, a feedback connection may be used to feed output of one layer in a neural network to an earlier layer. The neural network employs an adaptive learning mechanism, wherein the weights associated with connections between neurons are iteratively adjusted based on a predefined training algorithm, such as backpropagation with gradient descent or an alternative optimization technique.

A neural network may be trained using a learning methodology or a combination of learning methodologies such as supervised learning, unsupervised learning, reinforcement learning, etc. Performing the learning methodology (or combination of learning methodologies) enables the neural network to improve its performance over time by minimizing an error function or optimizing an objective criterion. Supervised learning may employ the use of supervised learning algorithms including, without limitation, naïve Bayes algorithms, regression algorithms (e.g., linear, nonlinear, logistic, polynomial, etc.), support vector machine (SVM) algorithms, K-nearest neighbor (KNN) algorithms, random forest algorithms, and deep learning algorithms. Unsupervised learning may employ the use of unsupervised learning algorithms including, without limitation, K-means clustering algorithms, hierarchical clustering algorithms, density-based spatial clustering of applications with noise (DBSCAN) algorithms, principal component analysis (PCA) algorithms, t-distributed stochastic neighbor embedding algorithms (t-SNE), autoencoder algorithms, isolation forest algorithms, one-class SVM algorithms, apriori algorithms, Eclat algorithms, generative adversarial network (GAN) algorithms, and deep learning algorithms. Examples of reinforcement learning include, without limitation, Q-learning algorithms, actor-critic algorithms, and policy iteration algorithms. Reinforcement learning may employ the use of reinforcement learning algorithms including, without limitation, Q-learning algorithms, State-Action-Reward-State-Action (SARSA) algorithms, policy gradient method algorithms, Monte Carlo method algorithms, and temporal difference learning algorithms. It should further be appreciated that generally, reinforcement learning involves the generation of a reward signal. Moreover, in reinforcement learning, the neural network may be trained to maximize the reward signal. Algorithms used in supervised, unsupervised, and/or reinforcement learning may not be mutually exclusive.

Applications of a neural network include, without limitation, image and speech understanding and generation, natural language processing (NLP), predictive analytics, anomaly detection, and autonomous decision-making systems. The architecture of the neural network may be customized by varying the number of layers, the type of activation functions (e.g. sigmoid function, Tanh activation function, rectified linear unit function, softmax function softplus function, etc.), connectivity patterns (e.g. skip connections, feedback connections, etc.), and training methodologies.

A deep neural network (DNN) comprising a multi-layered neural network for high-dimensional data processing, feature extraction, and predictive modeling. Examples of DNNs include, without limitation, convolutional neural networks (CNNs), recurrent neural networks (RNNs), multilayer perceptrons (MLPs), and combinations thereof. ML models are often implemented using a DNN.

Training a ML model generally involves a series of steps. Training may begin with acquiring raw input data which may undergo preprocessing steps such as data normalization, feature scaling, dimensionality reduction, missing value imputation, and augmentation techniques. In supervised learning, labelled datasets may be portioned into a training set, a validation set, and test sets. In unsupervised learning, clustering or transformation methods may be applied to the raw input data. Parameters for the ML model may then be initialized. For example, weights and biases associated with artificial neurons in the neural network, for applying weighted transformations, may be initialized. In some implementations, the parameters may be initialized using randomization, pretraining, or heuristic-based initialization techniques. During an iteration of training, a sample input is processed through the ML model, where each computational unit (artificial neuron) applies a weighted transformation followed by an activation function. The model may then generate an output which is compared against the expected result in supervised learning or, in the case of supervised or reinforcement learning, evaluated using an objection function. In the case of reinforcement learning, a reward signal may be generated based on the generated output. A loss function (e.g. mean squared error (MSE), cross-entropy loss, reinforcement learning reward functions, etc.) quantifies the discrepancy between the ML model's output and the desired outcome. To improve the ML model, (i.e. make the output closer to the desired output), optimization techniques such as stochastic gradient descent (SGD) algorithms, adaptive moment estimation (Adam), root mean square propagation (RMSprop) are used to adjust the parameters of the ML model. In some implementations, the optimization techniques may involve backpropagation wherein gradients of the loss function are computed with respect to the parameters of the ML model using the chain rule of differentiation. These gradients may guide the updating of the parameters in a direction that minimizes loss. To prevent overfitting and enhance model generalization, various regularization techniques may be applied during the training process. For example L1 and/or L2 regularization techniques may be used to introduce a penalty to the loss function for high-value correlated coefficients. Other regularization techniques include, without limitation, data augmentation, early stopping, dropout regularization, and batch normalization

The training process involves monitoring performance of the ML model using evaluation metrics such as accuracy precision-recall, F1-score, AUC-ROC, mean absolute error (MAE), and combinations thereof. Computing the evaluation metrics may involve processing the validation set with the ML model. Further, according to the evaluation metrics, hyperparameters of the ML model (e.g., number of layers in the neural network, learning rate, etc.) may be fine-tuned. A new iteration of the training process may be performed following the finetuning of the hyperparameters of the ML model. The training process may end when improvements in the ML model plateau.

In some implementations, after completing the training process, the test set may be used for a final evaluation of the ML model. Performance of the ML model may be evaluated using the evaluation metrics.

Upon completion of the training process, the parameters and hyperparameters of the ML model may be fixed and deployed for use.

In some implementations, a trained ML model may be finetuned, for example, for a specific task. That is, the parameters of the ML model may be adjusted to improve performance with respect to the specific task. The finetuning process of the ML model is similar to the training process as described herein. Typically, the dataset used to finetune the ML model is smaller than the dataset used to train the ML model.

A GNN is a type of neural network that is used to process graphs such as a graph that specifies a network topology. Tasks that can be performed by a GNN include, without limitation, graph classification, node classification, link prediction, community detection, generating graph embeddings, and graph generation.

A neural network may be implemented using neural network architecture known as a Transformer architecture or Transformer. Examples of Transformer-based neural networks include, without limitation, the Bidirectional Encoder Representations from Transformers (BERT) model, the Transformer-XL model, and the Generative Pre-trained Transformer (GPT) models. Transformer-based neural networks may take advantage of parallel processing capabilities of graphics processing units (GPUs), neural processing units (NPUs), and/or tensor processing units (TPUs) to efficiently process sequential data, thereby allowing it to perform computations efficiently. A GNN may also be implemented using a Transformer architecture.

A Transformer-based neural network may generate, based on input to the Transformer, a set of embeddings (or vectors or features) in an embedding space (or vector space or feature space). Embeddings/vectors may be considered numerical representations of the input. For example, a Transformer-based GNN may generate, for each node of a graph, an embedding or vector embedding. Likewise, the Transformer-based GNN may generate, for each edge of the graph, an embedding or vector embedding. In some implementations, a Transformer-based neural network may include an embedding layer, embedding module, or a project that performs the generation of the embeddings. Further, the embeddings layer, embedding module, or projector may be trained. For example, an embedding layer may be a linear transformation defined by parameters of the Transformer-based neural network. Moreover, the parameters may change or evolve as the Transformer-based neural network undergoes training. In some implementations of a Transformer-based neural network, such as a ML model that performs NLP (a large language model), prior to generating embeddings, the inputs may be tokenized via a tokenizer or tokenizing module. That is, the Transformer-based neural network may generate tokens based on the inputs to the neural network. These tokens may then be converted to embeddings/vectors/features.

The architecture of a Transformer-based GNN may include one or more Graph Attention (GAT) layers. A GAT layer implements an attention mechanism. An attention mechanism allows a Transformer-based neural network to “focus” on particular parts of the input (or embeddings/vectors/features) that are deemed important. In some Transformer-based neural networks, an attention mechanism is implemented as a transformation or mapping applied to embeddings/vectors/features. The transformation or mapping, once applied, outputs a new set of embeddings/vectors/features wherein the new set of embeddings/vectors/features captures information relating to the importance of each embedding/vector/feature.

In an implementation of a GAT layer, the GAT layer may generate, based on embeddings/vectors/features input to the GAT layer (input embeddings/vectors/features), new embeddings/vectors/features (output embeddings/vectors/features). To this end, the GAT layer may first apply a transformation to each input embedding/vector/feature to generate transformed embeddings/vectors/features. The GAT layer may then compute an attention coefficient for at least one pair of transformed embeddings/vectors/features. In some implementations, the GAT layer may compute an attention coefficient for all pairs. In other implementations, the GAT layer may compute an attention coefficient for a subset of the pairs. For example, for embeddings (transformed embeddings) corresponding to nodes of a graph, the GAT layer may compute an attention coefficient for nodes that are in the same neighborhood in the graph (e.g. at most 2 edges away from each other). The computed attention coefficient may be configured to indicate the importance of the embeddings (transformed embeddings) relative to each other. Further, the attention coefficients may be normalized. Going back to the example of a GAT layer that computes an attention coefficient for nodes that in the same neighborhood, the GAT layer may normalize the attention coefficient for a first node and second node across all nodes in the graph that are in the same neighborhood as the first node. The GAT layer may then use the normalized attention coefficients to compute the output embeddings/vectors/features. For example, going back to the example of a GAT layer that computes attention coefficients for the nodes in the same neighborhood, the output embedding corresponding to a node may be a linear combination of the normalized attention coefficients related to that node. In some implementations, the GAT layer may be implemented using multi-head attention. Multi-head attention allows the GAT layer to execute multiple attention mechanisms in parallel. The architecture of a Transformer-based GNN may include a series of GAT layers.

A Transformer-based neural network may include an encoder layer/block. An encoder layer/block may, in response to receiving input, output embeddings/vectors/features. In some implementations, the encoder layer/block may output the embeddings/vectors/features according to weighted transformations. An example of an encoder layer/block includes the embedding layer previously discussed. Another example includes a positional encoder that may add to embeddings in the embedding space, positional information related to the placement of the original token in the original sequence of tokens. In some implementations, the encoder layer/block may be considered a layer/block in the neural network that captures information relating to the input (tokenized input). That is, the outputted embeddings, vector representations and/or features capture information relating to the input. The encoder layer/block may comprise a series of connected layers in the Transformer-based neural network. The encoder layer/block may also be implemented using an attention mechanism. More specifically, in the case of Transformer-based GNN, the encoder layer/block may be implemented using one or more GAT layers.

A Transformer-based neural network may also include a decoder layer/block. The decoder layer/block may take in, as input, embeddings/vectors/features (such as the output of the encoder layer/block or a GAT layer) and generate output. For example, given embeddings/vectors/features corresponding to a graph, the decoder layer/block of a Transformer-based GNN may generate output corresponding to a classification of the graph. In some implementations, the decoder layer/block may feed the output back into the decoder layer/block to generate another output. That is, the decoder layer/block may continue to generate a sequence of output by feeding the output back into the decoder layer/block. For example, in the case of a Transformer-based GNN, the decoder layer/block may construct a path in a graph by inputting the last node (or corresponding embedding/vector/feature) of a partially constructed path back into the decoder layer/block to generate a next node (or new last node to put back into the decoder layer/block again) on the path. Generating output by inputting output back into the neural network (e.g. inputting back into the decoder layer/block) may be referred to as autoregressive or autoregressive generation. In some implementations, the decoder layer/block may output a “end” embedding/vector/feature that indicates to the neural network to stop the autoregressive process. That is, the neural network halts autoregressively generating output after receiving (outputting) the “end” embedding/vector/feature. The decoder layer/block may comprise a series of connected layers in the Transformer-based neural network. More specifically, in the case of a Transformer-based GNN, the decoder layer/block may be implemented using one or more GAT layers.

It should be appreciated that a Transformer-based neural network may comprise more than one encoder layer/block and more than one decoder layer/block. Some Transformer-based neural networks are implemented using both encoder layers/blocks and decoder layers/blocks. Such a Transformer-based neural network is used to implement the Text-to-Text Transfer Transformer (T5) model. Some Transformer-based neural networks, such as BERT, are implemented with only encoder layers/blocks. Further, some Transformer-based neural networks may be implemented using only decoder layers/blocks. A GPT model may be considered such an implementation of a Transformer-based neural network.

A Transformer-based neural network may further include a generator or generating module. The generator may convert the output of the decoder layer/block (such as a sequence of tokens) to a final output for the neural network. For example, if the decoder layer/block outputted a sequence embeddings/vectors/features corresponding to a path in a graph, the generator may generate sequence nodes, edges, or a combination thereof that corresponds to the path.

### Optical Network Planning and Routing

To assist in understanding the present disclosure, some concepts relevant to optical network planning and routing will be discussed.

As discussed previously with reference to FIG. 1, optical networks facilitate data communication between stations (or computers, routers, switches, etc.). When establishing or planning paths between stations/nodes connected to the optical network, in order to provide an optical experience to users of the optical network, it is imperative to plan, route, establish, and/or construct paths/lightpaths in the optical network that 1) maximize the number of satisfied service requests and 2) minimizes usage of network resources (e.g. the connections used by the path are minimized). Maximizing the number of satisfied requests may be considered akin to minimizing block probability. To this end, existing solutions to the network planning/routing problem use heuristic methods. Methods using heuristics include the shortest available path (SAP) and load balancing (LB) methods. Both of these methods involve the pre-computation of the k shortest paths for all node pairs in the network topology. In the SAP method, for each service request, the shortest option among the k shortest paths that has enough network resources (e.g. bandwidth/ODU, wavelength, etc.) to service the request is selected for servicing the request. In the LB method, with the objective of load-balancing (preventing bottlenecks in the optical network), a random path among the k shortest paths is selected for servicing the request (provided that there are sufficient network resources along the selected path). The SAP and LB methods both suffer from the drawback that computing the k shortest paths is inefficient. Specifically, the commonly used Yen's algorithm for computing the k shortest paths has a time complexity of O(kN³). Further, the SAP and LB methods inherently provide suboptimal solutions in optical network planning/routing.

Additionally or alternatively, other existing solutions to the optical network planning/routing problem use AI-assisted methods. Some of the AI-assisted methods operate on a “selection basis” and still involve the precomputation of the k shortest paths. These AI-assisted methods have the same drawbacks as the SAP method and the LB method.

Outside of the context of network planning/routing, AI-assisted methods involving an auto-regressive approach to construct paths have successfully been applied to classical graph traversal problems such as the Travelling Sales Person (TSP) and several variants of the Vehicle Routing Problem (VRP). However, these existing AI-assisted methods are solutions in specific cases where the topology of the graph is a complete graph. That is, these methods do not work for network topologies that are non-complete graphs.

The present disclosure will now move on to discuss a method and system for optical network planning/routing. In the discussed method/system, the method/system will use AI to construct (as opposed to select) a path/lightpath in the optical network.

### AI Architecture for Constructing Paths/Lightpaths in an Optical Network

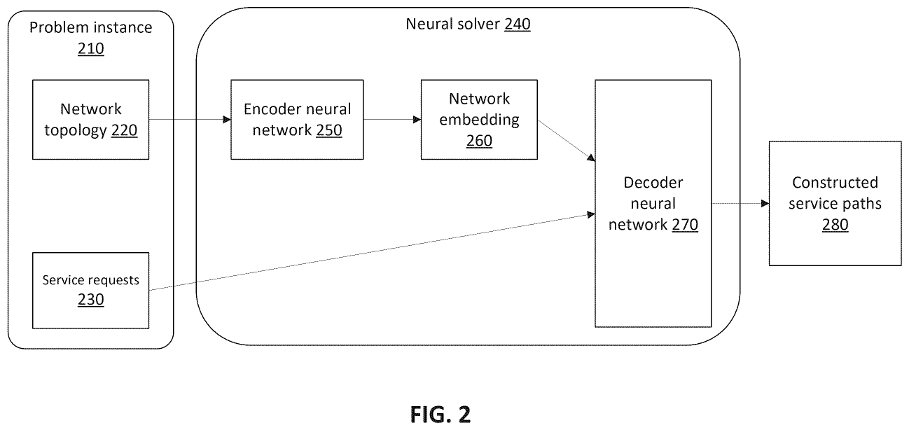

Reference is now made to FIG. 2 which is a simplified diagram illustrating an AI architecture for routing service requests in an optical network such as the optical network 180 (see FIG. 1). FIG. 2 shows a neural solver 240 that takes, as input, a problem instance 210, and outputs constructed service paths 280.

The problem instance 210 comprises a network topology 220 and one or more service requests 230. The network topology 220 may be specified by a connected graph and potentially attributes associated with each node and/or edge. Each of the one or more service requests 230 may comprise a source node (the node/station in the optical network from which data is to be transmitted from), a destination node (the node/station in the optical network to which data is to be transmitted to), and a bandwidth (or measure of network resource use) associated with servicing the service request.

In some embodiments, the one or more service requests 230 may be generated and/or received in response to a condition in the optical network. For example, a centralized controller of the optical network may implement the AI architecture shown in FIG. 2. In this example, the centralized controller may detect a failure in a connection in the optical network. In response thereto, the centralized controller may initiate a procedure involving restoring all paths/lightpaths in the optical network that use the affected or failing connection. For example, referring to FIG. 1, in a hypothetical scenario, the centralized controller may detect that the edge 148 is interrupted. Also suppose that in this hypothetical scenario, there is an established service path connecting the node 120 to the node 134. This service path may comprise the node 120, the edge 142, the node 124, the edge 148, the node 130, the edge 158, and the node 134. In this hypothetical scenario, in response to detecting that the edge 148 is failing, the centralized controller may initiate a procedure to restore a connection between the nodes 120 and 134 that allows the stations 110 and 116 to communicate. Thus, the centralized controller may generate a problem instance comprising a service request wherein the service request includes the node 120 as the source node and the node 134 as the destination node. If the station 110 was transmitting data to the station 116, the service request may further include bandwidth and/or a data transfer rate associated with the transmission. It should be appreciated that the example just discussed is for an optical network that employs a centralized controller for centralized restoration path computation. In another example, the AI architecture may be used for distributed restoration path computation. In such an example, the AI architecture may be implemented on a NE of one of the nodes 120-134.

The neural solver 240 is shown to comprise an encoder neural network 250 and a decoder neural network 270. The encoder neural network 250 takes, as input, the network topology 220, and in response thereto, outputs a network embedding 260. The encoder neural network 250 may be a GNN that captures the graph structure of the network topology 220 and summarizes the captured graph structure into embedding vectors for each node and/or connection in the network topology 220. That is, the network embedding 260 may include a plurality of embedding vectors for each node and/or edge in the network topology 220. The encoder neural network 250 may be implemented using Transformer blocks with GAT layers.

The decoder neural network 270 takes as input, the network embedding 260 and the one or more service requests 230. In response thereto, the decoder neural network 270 outputs the constructed service paths 280 for the one or more service requests 230. Specifically, the decoder neural network 270 is configured to construct a path/lightpath for a service request 230 autoregressively. That is, the decoder neural network 270 may construct a path/lightpath by 1) adding the source node to a partially constructed path/lightpath, 2) given the partially constructed path, add a next node to the partially constructed path, the next node being a node that is adjacent/connected to the source node via an edge in the network topology, 3) repeat step 2) but with the updated partially constructed path (the next node added until the destination node is reached. Put another way, the decoder neural network 270 may be configured to construct a path/lightpath in the network topology 220 for the service request 230 according to the following pseudocode:

path = empty;
path = path+source_node;
while path[−1] != destination_node:
path = path+next_node(path)
return path

where path[−1] denotes the last node of the path/partially constructed path, the + operation denotes adding a node to the path via an edge connecting the node to path[−1], and next_node(path) is a next node selected/computed/output by the decoder neural network 270 to add to the path. While not explicit in the provided pseudocode, next_node(path) factors in the network topology 220 (via the network embedding 260) and bandwidth/capacity considerations.

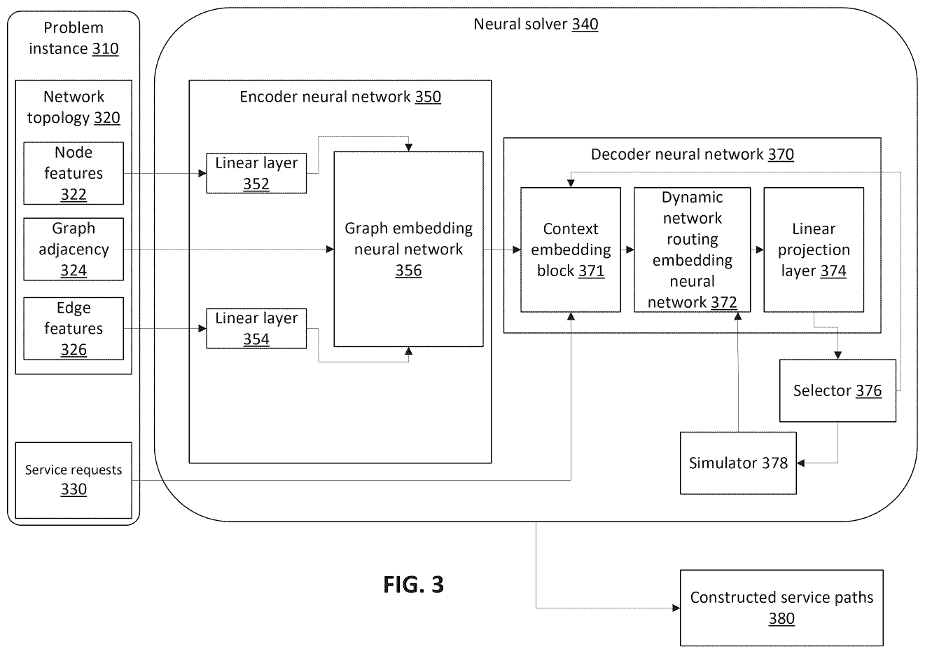

Reference is now made to FIG. 3 which is a simplified diagram illustrating an implementation of the AI architecture of FIG. 2. Similar to FIG. 2, FIG. 3 shows a problem instance 310, a neural solver 340, and constructed service paths 380.

Similar to FIG. 2, the problem instance 310 comprises a network topology 320 and one or more service requests 330. The network topology 320 is shown comprising node features 322, graph adjacency 324, and edge features 326. The node features 322 may be data representative of attributes of the nodes in the network topology 320 (e.g. location identifying data of the nodes such as Cartesian coordinates or geographic coordinates). Likewise, the edge features 326 may be data representative of attributes of the connections in the network topology 320 (e.g. bandwidths/data transfer rates of the connections in terms of ODU containers, available wavelengths for WDM, etc.). The graph adjacency 324 may be a data structure representative of how the nodes in the network topology 320 are connected/adjacent to each other. Examples of such a data structure include without limitation a graph adjacency matrix. Going back to FIG. 1, in the case of the optical network 180, the following graph adjacency matrix may be used as the graph adjacency 324.

$$[ \begin{matrix}0 & 1 & 1 & 0 & 0 & 0 & 0 & 0 \\ 1 & 0 & 1 & 0 & 0 & 0 & 0 & 0 \\ 1 & 1 & 0 & 1 & 1 & 1 & 0 & 0 \\ 0 & 0 & 1 & 0 & 0 & 1 & 0 & 0 \\ 0 & 0 & 1 & 0 & 0 & 1 & 0 & 0 \\ 0 & 0 & 1 & 1 & 1 & 0 & 1 & 1 \\ 0 & 0 & 0 & 0 & 0 & 1 & 0 & 1 \\ 0 & 0 & 0 & 0 & 0 & 1 & 1 & 0\end{matrix} ]$$

where the rows and columns are indexed by the reference numerals in FIG. 1 for the nodes 120-134 in increasing order, o denotes that there is no connection between node pairs (column and row intersection), and 1 denotes that there is a connection between node pairs (column and row intersection).

It should be appreciated that a network topology may be represented using a graph or graph structure. As such, throughout the disclosure, nomenclature relating to graphs may be used, where applicable, to refer to parts or components of the network topology. For example, “nodes” (graph theory) may be used to refer to nodes in the optical network. Likewise, “edges” may be used to refer to fiber links or connections in the optical network.

The one or more service requests 330 may be similar to the one or more service requests 230 as discussed with reference to FIG. 2.

The neural solver 340 is shown taking, as input, the problem instance 310 and outputting the constructed service paths 380 for the one or more service requests 330. Specifically, the neural solver 340 is shown including an encoder neural network 350 and a decoder neural network 370. The encoder neural network 350 is further shown comprising a linear layer 352, a linear layer 354, and a graph embedding neural network 356. The linear layers 352 and 354 may be fully-connected feed-forward neural networks. In particularly, the linear layer 352 may take, as input, the node features 322 and output initial node embeddings for the node features 322. Each of the nodes of the network topology 320 may have a corresponding vector embedding in the initial node embeddings. Likewise, the linear layer 354 may take, as input, the edge features 326 and output initial edge embeddings for the edge features 326. Each of the edges of the network topology 320 may have a corresponding vector embedding in the initial edge embeddings.

FIG. 3 shows the graph embedding neural network 356 taking, as input, the graph adjacency 324 and the outputs of the linear layers 352 and 354. That is, in addition to the graph adjacency 324, the graph embedding neural network takes, as input, the initial node embeddings and the initial edge embeddings. The graph embedding neural network 356 outputs a network embedding. The network embedding may comprise vector embeddings that capture all information about the network topology 320. In some embodiments, the network embedding may comprise a vector embedding for each of the nodes and/or edges in the network topology. The graph embedding neural network 356 may be implemented as a GNN. Further, the graph embedding neural network 356 may comprise one or more Transformer blocks with GAT layers along with other common elements of Transformers such as batch normalizers, skip connections, and linear layers.

The decoder neural network 370 takes, as input, the network embedding output by the encoder neural network 350 and the service requests 330 to output or generate the constructed service paths 380. FIG. 3 shows the decoder neural network 370 comprising a context embedding block 371, dynamic network routing embedding neural network 372, and a linear projection layer 374. The context embedding block 371 extracts and assembles the vector embeddings of the nodes and edges in the network topology 320 including the source node and the destination node or a path/lightpath to be constructed. The context embedding blocks 371 further assembles and extracts embeddings/data related to the current demand. Current demand may refer to the service request being processed by the decoder neural network 370. For example, in some embodiments, the service requests 330 may be a plurality of service requests and the neural solver 340 may construct a path/lightpath for each of the plurality of service requests in series. In such embodiments, in an iteration of the series, the context embedding block 371 may assemble and extract embeddings/data related to the source node and destination node of a current one of the plurality of service requests being processed (referred to as “current demand”). The context embedding block 371 may further assemble and extract embeddings/data related to a partially constructed path/lightpath for a service request. Specifically, the decoder neural network 370 is designed to construct a path/lightpath for a service request autoregressively. As such, after determining a next node (adding the next node to the partially constructed path), the next node may be input back into the decoder neural network 370 to determine a following node in the partially constructed path. In summary, the context embedding block 371 takes, as input, the embeddings/data related to the current demand, the partially constructed path, and the network topology and outputs contextual embeddings that captures the embeddings/data thereof.

The dynamic network routing embedding neural network 372 takes, as input, the contextual embeddings and a dynamic network state to construct a path for the service requests 330. The dynamic network state may be embeddings/data relating to available capacities, bandwidths, or ODU containers of the network topology. As discussed previously, the decoder neural network 370 is designed to construct a path/lightpath autoregressively. As such, upon determining the next node and adding the next node to a partially constructed path/lightpath, the dynamic network state may be updated to reflect use of the connections in the partially constructed path from the source node to the next node. Similar to the graph embedding neural network 356, the dynamic network routing embedding neural network 372 may be implemented using Transformer blocks with GAT layers.

The output of the dynamic network routing embedding neural network 372 may be processed by the linear projection layer 374. The resulting output of the linear projection layer 374 may correspond to a probability distribution over all network nodes for choosing/sampling a next node on the path/partially constructed path. In a greedy implementation of the AI architecture, the decoder neural network may construct the path/lightpath for a service request by choosing the node with the greatest probability in the probability distribution to be the next node. It should be appreciated that there exist other implementations besides the greedy implementation. For example, the next node may be selected from nodes in the probability distribution that have a probability within a predetermined range. Additionally or alternatively, the decoder neural network 370 may be configured to select a sample of nodes based on the probability distribution. The paths/lightpaths may then be constructed, in a post-processing step, based on the selected sample nodes from each iteration of the autoregressive process for constructing a path for the service request. FIG. 3 shows the neural solver 340 comprising a selector 376. The selector 376 may be a module in the neural solver 340 that chooses/samples a next node as described above. In line with the autoregressive nature of the AI architecture, FIG. 3 shows the output of the selector, the next node, being input into the context embedding block 371. Thus, the decoder neural network 370 will continue to select/choose/sample nodes in the network topology until a path from the source node of a service request to a destination node of the service request is constructed.

FIG. 3 further shows a simulator 378. The simulator 378 may be a module in the decoder neural network 370 that updates the dynamic network state in response to selecting/choosing/sampling the next node. In line with the autoregressive nature of the AI architecture, the output of the simulator 378, the updated dynamic network state, is shown being input into the dynamic network routing embedding neural network 372. In some embodiments, the dynamic network state may be captured as a network connectivity matrix or represented as an embedding vector before being input to the dynamic network routing embedding neural network 372. As such, the output of the simulator 378 may be a matrix or an embedding vector.

Upon iteratively and autoregressively constructing paths/lightpaths for the service requests 330, the neural solver 340 may output a final solution which contains the constructed service paths 380.

The neural solver 340 may be trained using reinforcement learning. The training process may involve using masking techniques to mask invalid actions for node selection by the decoder neural network 370 (for selecting the next node) and allowing the decoder neural network 370 to append to the partial solution (partially constructed path) a node that is connected to the partial solution but not visited (in the partial solution) yet.

Reinforcement learning uses a reward signal to modify, without limitation, weightings and/or parameters of the neural solver 340. The reward signal may be a scalar quantity that captures the overall quality of the computed constructed service paths. In some embodiments, during training, the reward signal may be generated using the following pattern:

$$Reward = \{ \begin{matrix}negative value of some measure of network resources used & if success \\ a fixed large negative value ( penalty ) & if failure\end{matrix}$$

A more specific example of the reward signal may take the following formula:

$$Reward = \{ \begin{matrix}- bwd\_ratio * num\_hops & if success \\ - 10 * num\_net \_nodes & if failure\end{matrix}$$

where bwd_ratio denotes a coefficient proportional to the number of ODU0 containers required for provisioning a service request, num_hops denotes the length of a constructed service path (measured according to the number of edges/connections in the path), and num_net_nodes denotes the number of nodes in the optical network/network topology. As the formula indicates, a reward signal may be generated for each one of the constructed service paths (i.e. each one of the (sample) service paths used for training).

It should be appreciated that training the neural solver 340 via reinforcement learning may comprise training both the encoder neural network 350 and the decoder neural network 370, either jointly or separately, via reinforcement learning.

In some embodiments, the encoder neural network 350 or the graph embedding neural network 356 may be trained using self-supervised learning techniques such as, without limitation, graph contrastive learning methods. This self-supervised learning of the encoder neural network 350 may be a pre-training step. That is, the encoder neural network 350 may be trained via self-supervised learning prior to training the neural solver 340 via reinforcement learning. It should be appreciated that such pre-training may speed up the reinforcement learning process. Specifically, with respect to the reinforcement learning, the self-supervised pre-training may allow for a sped-up training convergence and an improved sample efficiency.

It should be appreciated that the AI architecture depicted in FIG. 3 may also be used for optical networks that employ WDM. In such embodiments, the edge features 326 may include, available wavelengths of the corresponding connection in the optical network for WDM. Further, in such embodiments, the output of the linear projection layer 374 may include, in addition to a probability distribution for selecting/sampling nodes for the next node, another probability distribution for selecting a wavelength to get to the next node from the last node of the partially constructed path. In some embodiments, the probability distribution for the nodes and the probability distribution for the wavelengths may be separate. In other embodiments, the probability distributions may be joint into one probability distribution. In these embodiments, for optical networks that employ WDM, the selector 376 may be configured to select (as part of an autoregressive construction of a path/lightpath) a wavelength from the described probability distribution for wavelengths. Further, the simulator 378 may update the dynamic network state according to the selection of the wavelength by the selector 376. It should further be appreciated that, in the case of optical network that employ WDM, the selector 376 may be configured to select/assign/sample nodes and wavelengths according to constraints specific to WDM. For example, WDM requires wavelength continuity. That is, in WDM, a lightpath uses the same wavelength throughout. Accordingly, for WDM, the neural solver 340 may be configured to construct lightpaths such that for any given one of the constructed service paths 380, one wavelength is used throughout that one of the constructed service paths 380. In these embodiments that relate to optical networks employing WDM, the reward signal may take on the following formula:

$$Reward = \{ \begin{matrix}- num\_hops & if success \\ - 10 * num\_net \_nodes & if failure\end{matrix}$$

It should be further be appreciated that the AI architecture in FIG. 3 may also be used for optical networks that employ RMSA. In such embodiments, the output of the linear projection layer 374 may further include a probability distribution for modulation assignment and/or a probability distribution for spectrum assignment. The selector 376 and the simulator 378 may be accordingly configured.

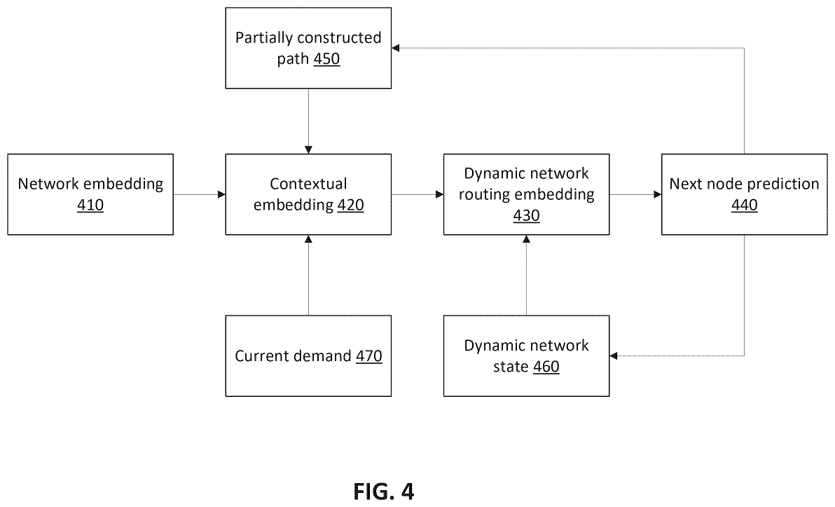

Reference is now made to FIG. 4 which is a process flow diagram illustrating interactions of data/embeddings in an embodiment of the AI architecture in FIG. 3. Specifically, FIG. 4 shows data/embeddings used by the decoder neural network 370 to construct the constructed service paths 380.

FIG. 4 shows a network embedding 410 (generated/output by the encoder neural network 350), a partially constructed path 450, and a current demand 470 (picked from the service requests 330) being used to generate (via the context embedding block 371) a contextual embedding 420. The contextual embedding 420 and a dynamic network state 460 may then in turn be used to generate (via the dynamic network routing embedding neural network 372) a dynamic network routing embedding 430. The dynamic network routing embedding 430 is then used to predict a next node prediction 440. The next node prediction 440 may be selected based on a probability distribution (such as the probability distribution generated/output by the linear projection layer 374). The next node prediction 440 may be added to the partially constructed path 450. Put another way, the dynamic network routing embedding 430 is used to predict a node (referred to as the “next node prediction 440”) to add to the partially constructed path 450. Further, the dynamic network state 460 may be updated (via the simulator 378) according to the next node prediction 440. In this manner, the decoder neural network 370 may iteratively and autoregressively construct a path/lightpath for any one of the service requests 330.

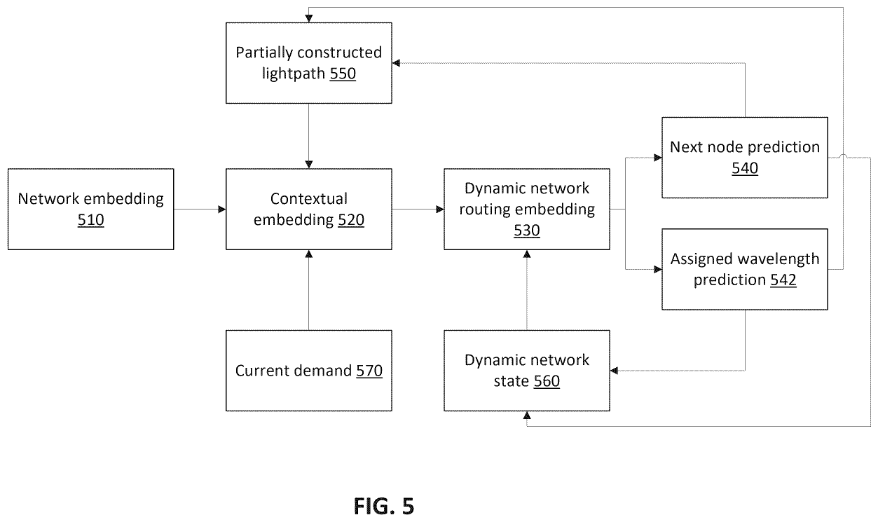

Reference is now made to FIG. 5 which is also a process flow diagram illustrating interactions of data/embeddings in an embodiment of the AI architecture in FIG. 3. Specifically, FIG. 5 shows data/embeddings used by the decoder neural network 370 to construct the constructed service paths 380 in an optical network that employs WDM and/or RWA.

Similar to FIG. 4, FIG. 5 shows a network embedding 510, a contextual embedding 520, a dynamic network routing embedding 530, a next node prediction 540, a partially constructed lightpath 550, a dynamic network state 560, and a current demand 570. Each may, respectively, be similar to the network embedding 410, the contextual embedding 420, the dynamic network routing embedding 430, the next node prediction 440, the partially constructed path 450, the dynamic network state 460, and the current demand 470 as described with reference to FIG. 4. FIG. 5 further shows the dynamic network routing embedding 530 being used to predict a wavelength assignment prediction 542. The wavelength assignment prediction 542 may be selected based on a probability distribution (output by the linear projection layer 374). Further, the partially constructed lightpath 550 and the dynamic network state 560 may be updated based on the wavelength assignment prediction 542. Put another way, the dynamic network routing embedding 530 is used to predict a wavelength (referred to as the “assigned wavelength prediction 542”) to use for the edge connecting the next node prediction 540 to the partially constructed lightpath 550.

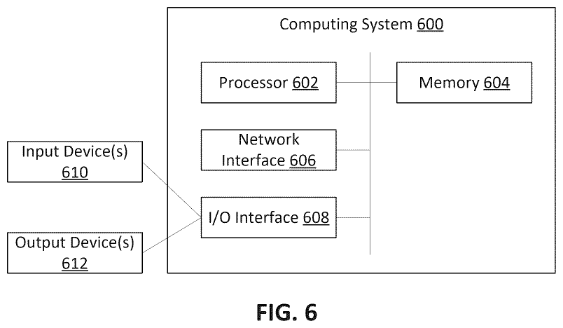

Reference is now made to FIG. 6 which illustrates an example computing system 600 which may be used to implement examples of the present disclosure such as the AI architectures shown in FIG. 2 or FIG. 3. Additionally or alternatively, one or more instances of the example computing system 600 may be employed to implement the discussed AI architectures. For example, a plurality of instances of the example computing system 600 may cooperate to implement the discussed AI architectures. It should further be appreciated that, to the end of implementing the AI architectures shown in FIGS. 2 and 3, the computing system 600 may reside on a standalone computer running the planning tools for batch service provisioning of an optical network. Additionally or alternatively, the computing system 600 may reside on a NE on a source node station for distributed restoration path computation. Additionally or alternatively, the computing system 600 may reside on a centralized controller of the optical network for online service provisioning or centralized restoration path computation.

The example computing system 600 includes at least one processing unit, such as a processor 602, and at least one physical memory 604. The processor 602 may be, for example, a central processing unit, a microprocessor, a digital signal processor, an application-specific integrated circuit (ASIC), a field-programmable gate array (FPGA), a dedicated logic circuitry, a dedicated AI processor unit, a GPU, a TPU, a NPU, a hardware accelerator, or combinations thereof. The memory 604 may include a volatile or non-volatile memory (e.g., a flash memory, a random-access memory (RAM), and/or a read-only memory (ROM)). The memory 604 may be a non-transitory computer-readable medium storing instructions for execution by the processor 602, to the computing system 600 to carry out examples of the methods, functionalities, systems and modules disclosed herein.

The computing system 600 may also include at least one network interface 606 for wired and/or wireless communications with an external system and/or network (e.g., an intranet, the Internet, a P2P network, a WAN and/or a LAN). A network interface may enable the computing system 600 to carry out communications (e.g., wireless communications) with systems external to the computing system 600, such as a language model residing on a remote system. Further the network interface 606 may allow the computer system 100 and/or the processor 602 to interact with an optical network. For example, the processor 602 may monitor an optical network via the network interface 606. Additionally or alternatively, the processor may instruct nodes and/or links in an optical network to establish a path in the optical network or, in the alternative, allocate resources to establish a path in the optical network.

The computing system 600 may optionally include at least one input/output (I/O) interface 608, which may interface with optional input device(s) 610 and/or optional output device(s) 612. Input device(s) 610 may include, for example, buttons, a microphone, a touchscreen, a keyboard, etc. Output device(s) 612 may include, for example, a display, a speaker, etc. In this example, optional input device(s) 610 and optional output device(s) 612 are shown external to the computing system 600. In other examples, one or more of the input devices 610 and/or output device(s) 612 may be an internal component of the computing system 600.

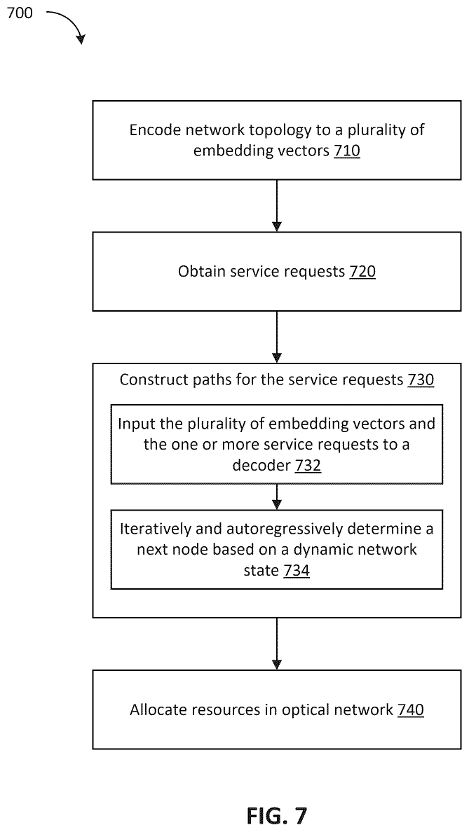

Reference is now made to FIG. 7 which illustrates, in flowchart form, a method 700 for routing service requests in an optical network using an AI architecture such as the AI architectures shown in FIGS. 2 and 3. The method 700 may be implemented by one or more computing devices having suitable processor-executable instructions for causing the one or more computing devices to carry out the described operations. The method 700 may be implemented, in whole or in part, by a computing system such as the computer system 600 or multiple such computing systems in cooperation. As setup to the method 700, the computer system or one of the systems (in the event of multiple computing systems) may maintain an AI architecture as discussed with reference to FIGS. 2 and 3.

The method 700 begins with an operation 710. At the operation 710, the system may encode a network topology to a plurality of embedding vectors. Specifically, the system may encode a network topology of an optical network using an encoder neural network to encode a plurality of nodes and a plurality of edges connecting pairs of the plurality of nodes to generate a plurality of embedding vectors. The encoder neural network may be a graph neural network. The encoder neural network may be the encoder neural network 350 as described with reference to FIG. 3. It should be appreciated that the nodes may be associated with node features such as Cartesian or geographic coordinates. Likewise, the edges may also be associated with edge features such as associated bandwidths/capacities or available wavelengths or spectrum slots (for RWA or RMSA). Further, the network topology may be defined by, without limitation, graph adjacency data such as an adjacency matrix.

Following the operation 710, the system may execute the operation 720. At the operation 720, the system may obtain one or more service requests such as the one or more service requests 230 or the one or more service requests 330 (see FIGS. 2 and 3). Each one of the service requests may be associated with a respective source node and a respective destination node in the network topology. That is, the plurality of nodes may include the respective source node and the respective destination node.

In some embodiments, the service requests may be generated in response to a condition in the optical network. For example, one of the one or more service requests may be generated in response to detecting a network failure. For example, the system may detect that the optical network is failing to transmit data, along a failing path in the optical network, from a point A in the optical network to a point B in the optical network. In response thereto, the system may generate a service request to transmit data from point A to point B or, alternatively, the system may receive the service request from an external system (such as a monitoring system) that generated the service request. In this example, the service request may result in a new path/lightpath from point A to point B that will not fail, or at the very least, fail less. In some embodiments, the method 700 may be to be executed by multiple computer systems wherein one of the systems maintains the AI architecture and another one monitors the optical network system. Further, in such embodiments, the system maintaining the AI architecture and the system monitoring the optical network may be in disparate locations but also be, or be considered, parts of the same computer system.

It should be appreciated that while FIG. 7 shows the system executing the operation 720 after the operation 710, the execution of the operation 720 need not be restricted in such a manner. That is, the operations 710 and 720 may be executed in an order or simultaneously.

Following the operation 720, the system may execute an operation 730. At the operation 730, the system may construct paths for the one or more service requests. Specifically, the system may construct, for each one of the one or more service requests, a respective path/lightpath in the network topology from the respective source node to the respective destination node using a decoder neural network such as the decoder neural network 370 as described with reference to FIG. 3. The operation 730 may further include suboperations 732 and 734. In the suboperation 732, the system may input the plurality of embedding vectors and the one or more service requests to the decoder neural network. That is, the output of the encoder neural network may be input to the decoder neural network along with the one or more service requests. In the suboperation 734, the system may, via the decoder neural network, for each of the respective paths, starting from the respective source node, iteratively and autoregressively determine a next node on the respective path based on a dynamic network state. The iterative and autoregressive determining of the next node may be similar to the autoregressive process used in path constructed as described with reference to FIGS. 2-5.

In some embodiments, the construction of the respective service paths may use a probability distribution. Specifically, in an iteration of the autoregressive construction of a service path, the decoder neural network may be configured to generate a probability distribution over the plurality of nodes. In a greedy implementation, the node in the probability distribution with the greatest probability may be selected as the next node. That is, the next node may correspond to the greatest probability in the probability distribution. It should be appreciated that there are other implementations besides the greedy implementation. For example, during the autoregressive process of path construction, instead of selecting a next node from the probability distribution, a sample, or next sample, may be selected based on the probability distribution. Then, in a post-processing step, the system or decoder neural network may construct the service path based on the autoregressively selected samples. That is, the decoder neural network may be configure to, for each of the respective paths, starting from the respective source node, iterative and autoregressively 1) generate a probability distribution for determining the next node on the respective path based on the dynamic network state and 2) determine, based on the probability distribution, a sample of one or more of the plurality of nodes. The system or decoder neural network may afterwards construct each of the respective paths based on the samples of the one or more of the plurality of nodes.

It should further be appreciated that, in some embodiments, the service requests are associated with respective bandwidths (perhaps in terms of ODU containers or data transfer rates requires for provisioning the service request). In these embodiments, the dynamic network state may indicate, based at least on the respective capacities of the plurality of edges, available capacities in the network topology. Further, in these embodiments, in response to autoregressively determining the next node on the respective path of one of the one or more service requests, and prior to another iteration of the autoregressive determining, the system or decoder neural network may update the dynamic network state based on the respective bandwidth of the service request. It should further be noted that in these embodiments, the dynamic network state may be maintained throughout the process of constructing the respective paths for all, or at least multiple, of the service requests. That is, after the construction of a respective path for a first one of the one or more service requests, the updated dynamic network state may be carried through (not reset) and used for autoregressively constructing a respective path for a second one of the one or more service requests. While constructing the respective path for the second one of the one or more service requests, the dynamic network state may continue to be updated. Put another way, the system or decoder neural network may 1) maintain, subsequent to determining the respective path of one of the one or more service requests, the dynamic network state, and 2) construct, using the dynamic network state, the respective path of another one of the one or more service requests.

Following the operation 730, the system may execute an operation 740. At the operation 740, the system may allocate resources in the optical network. Specifically, the system may instruct one or more of a plurality of optical nodes corresponding to the plurality of nodes and one or more of a plurality of links corresponding to the plurality of edges to allocate resources to establish, for each of the constructed respective paths, corresponding service paths in the optical network. In an example embodiment, as described with reference to FIG. 1, the optical network may be the optical network 180, the plurality optical nodes may be the nodes 120-134, and the plurality of links may be the edges 140-158.

It should further be appreciated that the method 700 may be applicable to WDM optical networks for solving RWA or RMSA problems. In the case of RWA, each of the plurality of edges may be associated with one or more respective wavelengths. Further, the decoder neural network may further be configured to determine, along with the next node, an assignment of one of the one or more respective wavelengths associated with an edge connecting the next node to a previous node on the respective path. The previous node may be considered the last node of the respective path prior to adding the next node to the respective path. It should be appreciated that in WDM, the same wavelength is used throughout the same lightpath. Accordingly, the decoder neural network may be configured to construct a service lightpath employing the same wavelength for a particular service request. For example, referring to FIG. 1, in a WDM optical network a lightpath from the node 120 to 134 following the edges 142, 148, and 158 may use a blue wavelength throughout. Further, a different lightpath from the node 120 to 134 using the same edges, and being used concurrently with the blue lightpath, may use a red wavelength throughout. In the case of RMSA, each of the plurality of edges may be associated with a respective available spectrum or spectrum slots. Further, the decoder neural network may determine, along with the next node, an assignment of a segment of the spectrum or spectrum slots associated with the edge connecting the next node to the previous node on the respective path. The decoder neural network may further determine an assignment of a modulation for the edge connecting the next node to the previous node on the respective path. It should be appreciated that, unlike the spectrum segment or spectrum slots, modulation may not be associated with any of the plurality of edges. Rather, modulation may be considered an attribute of a lightpath. Further, the rate of the assigned modulation and the width of the assigned spectrum segment/spectrum slots may be inversely related. The assignment of the modulation and spectrum segment/spectrum slots consequently results in, during execution of transmission of data along the respective path/lightpath, when transmitting data from the previous node to the next node, data being transmitted via the assigned modulation and spectrum segment/spectrum slots. Further, the same modulation and spectrum slots may be used throughout the same respective path/lightpath. That is, given any respective path/lightpath constructed according to RMSA, the edges connecting the nodes in the respective path/lightpath may use the same modulation and the same spectrum segment/spectrum slots.

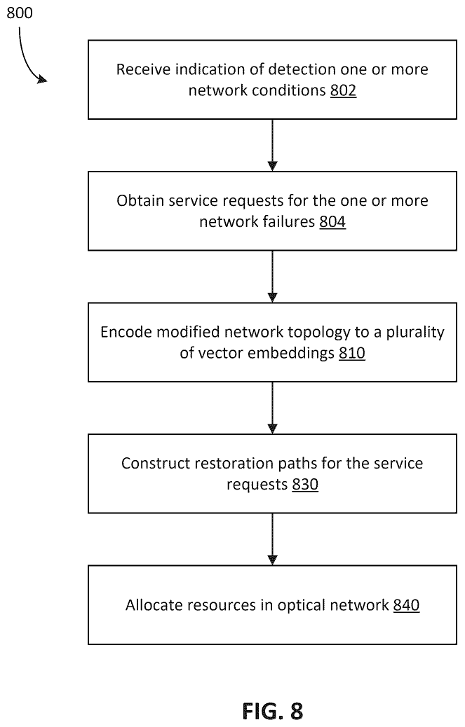

Reference is now made to FIG. 8 which illustrates, in flowchart form, a method 800 for routing service requests in response to detecting a network condition in an optical network. The method 800 may be implemented by one or more computing devices having suitable processor-executable instructions for causing the one or more computing devices to carry out the described operations. The method 800 may be implemented, in whole or in part, by a computing system such as the computer system 600 or multiple such computing systems in cooperation. As setup to the method 800, the computer system or one of the systems (in the event of multiple computing systems) may maintain an AI architecture as discussed with reference to FIGS. 2 and 3.

The method 800 begins with an operation 802. At the operation 802, the system receives an indication of detection of one or more network conditions. A network condition may be, for example, a network failure, weak signal strength, a fiber cut in the optical network, etc. Referring to FIG. 1, the edge 148 being cut is an example of a network failure or fiber cut. Consequent to the edge 148 being cut, all paths/lightpaths in the optical network 180 that use the edge 148 may no longer be functional because optical signals may be unable to travel along the edge 148. In another example, a network failure may be caused by a node failure. For example, a board of node that converts electrical signals to optical signals may malfunction, thereby compromising paths/lightpaths that use that node to fail. In some embodiments, the system may receive the indication of the one or more network conditions from an external system that detects network conditions in the optical network (e.g. network monitoring system or centralized controller). In such embodiments, the received indication may be akin to or include a list of service requests wherein the service requests in the list include recomputing/restoring service paths that have been affected by the detected network condition. Accordingly, these service requests may include respective source nodes, respective destination nodes, and respective bandwidths. It should be appreciated that in these embodiments, the external system may generate the service requests in response to detecting the one or more network conditions. In another example of an embodiment where the detection is performed by an external system, the indication may be a list of service paths affected by the network condition. In other embodiments, the system itself may detect the one or more network conditions. In such embodiments, the indication may be the detection of the one or more network conditions itself.

Following the operation 802, the system may execute an operation 804. At the operation 804, the system may obtain, in response to receiving the indication of the detection of the one or more network conditions, one or more service requests relating to the one or more network conditions. A given service request may include a respective source node and a respective destination node. In particular, the respective source node and the respective destination node may be the source node and the destination of a service path in the optical network that has been affected by the network condition (network failure). For example, referring to FIG. 1, if the edge 152 fails (e.g. fiber cut) and there is a compromised service path from the node 120 to the node 134 wherein the compromised service path uses the edge 152, a service path from the node 120 to the node 134 may need to be recomputed/restored. Accordingly, one of the service requests obtained in response to receiving the indication of the network condition/network failure (failure of the edge 152) may include the node 120 (the respective source node) and the node 134 (the respective destination node). In some embodiments, “obtaining” the service requests may include receiving the service requests from an external system that detected the network conditions and generated the service requests accordingly. In other embodiments, “obtaining” the service request may include receiving, from a similar external system, a list of affected service paths and, in response thereto, generating corresponding service requests. In yet further embodiments, such as an embodiment wherein the system itself detects the one or more network conditions, “obtaining” the service requests may include generating the service requests. It should be appreciated that more than one service request may be obtained for one network condition. For example, in the event of a fiber cut, all service paths using the cut fiber may need to be recomputed. That is, the system may obtain a service request for each of the service paths affected by the fiber cut. While the example just discussed refers to a network condition/network failure arising from a fiber cut, similar logic applies to a scenario where a node causes the network condition/network failure. That is, in the event of a node failure, the system may recompute all service paths using the failing node. It should also be appreciated that in some embodiments, all service paths may be recomputed in response to detection of a network condition/network failure. That is, in such embodiments, a service request is obtained per established service path at the time of detection of the network condition/network failure.

It should be appreciated that in embodiments where the detection of the network condition and the recomputing of the service paths are performed by different systems, both systems may be, or be considered, part of the same computer system even if the systems are in disparate locations.

Following the operation 804, the system may execute an operation 810. At the operation 810, the system may encode a modified network topology. The operation 810 may be executed similarly to the operation 710 of the method 700 as described with reference to FIG. 7. It should be appreciated that while FIG. 8 shows the operation 810 executing after the operations 802 and 804, in some embodiments, the operation 810 may be executed before the operation 802. That is, the network topology may be encoded to a plurality of embedding vectors before or after detecting the one or more network conditions. It should further be appreciated that the network topology being encoded may be considered “modified” due to the detected one or more network conditions. For example, a failing edge (e.g. fiber cut) in the optical network would modify the network topology because the failing edge would be removed from the network topology. In another example, a failing node in the optical network would modify the network topology because the failing node and its adjacent edges would be removed from the network topology.

Following the operation 810, the system may execute operation 830. At the operation 830, the system may construct restoration paths for the service requests. The operation 830 may be executed similarly to the operation 730 of the method 700 as described with reference to FIG. 7. It should be appreciated that the paths be constructed may be considered restoration paths because they may be recomputations/restorations of service paths that were affected due to the detected one or more network conditions.

Following the operation 830, the system may execute an operation 840. The operation 840 may be executed similarly to the operation 740 of the method 700 as described with reference to FIG. 7.

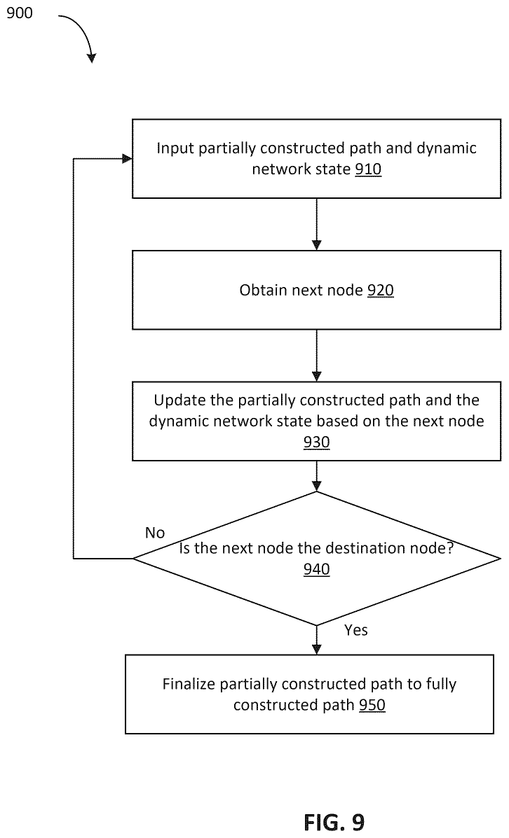

Reference is now made to FIG. 9 which illustrates, in flowchart form, a method 900 for iteratively and autoregressively constructing a path in an optical network via the use of an AI architecture such as the ones shown in FIGS. 2 and 3. The method 900 may be implemented by a computing device having suitable processor-executable instructions for causing the computing device to carry out the described operations. The method 900 may be implemented, in whole or in part, by a computing system such as the computer system 600. As setup to the method 900, the computer system may maintain an AI architecture as discussed with reference to FIGS. 2 and 3. It should be appreciated that the method 900 may be considered a process executed by the decoder neural network 370 (see FIG. 3) when autoregressively constructing a path/lightpath for a service request.

The method 900 begins with an operation 910. At the operation 910, the system/decoder neural network may input a partially constructed path and a dynamic network state into the decoder neural network. The partially constructed path may be an incomplete path from a source node of the service request to the destination node. In particularly, the incomplete path has not reached the destination node yet. In some scenarios, during the operation 910, the partially constructed path may only include the source node. The dynamic network state may be considered a variable or model that tracks available capacities of links/connections in the optical network. If a node and link are selected during construction of a path/lightpath, the dynamic network state may be accordingly updated.

Following the operation 910, the system may execute an operation 920. At the operations 920, the system/decoder neural network may obtain a next node. Specifically, the system/decoder neural network may obtain a next node to append to the partially constructed path. The next node may be a node that is connected to the last node of the partially constructed path in the network topology. Moreover, the link/edge/connection connecting the last node to the next node has sufficient capacity for the service request. In some embodiments, as discussed with reference to at least FIG. 3, the next node may be selected according to a probability distribution generated by the decoder neural network in response to being input the dynamic network state, the partially constructed path, and embedding vectors capturing a network topology of the optical network.

Following the operation 920, the system may execute an operation 930. At the operation 930, the system/decoder neural network may update the partially constructed path and the dynamic network state based on the next node. That is, the next node may be appended to the partially constructed path. Further, the dynamic network state may be updated to reflect resource usage in the edge/link/connection connecting the next node to the previous/last node of the partially constructed path.

Following the operation 930, the method 900 may proceed to a decision 940. At the decision 940, the system/decoder neural network determines if the next node (appended node) is the destination node. If the next node (appended node) is not the destination node (that is the destination node has not been reached yet), the method 900 returns to the operation 910. Otherwise, the method 900 proceeds to an operation 950 where the system finalizes the partially constructed path to a fully constructed path. That is, the system determines that, with the addition of the next node, the partially constructed path is now a constructed path that can transmit data from the source node of the service request to the destination node of the service requests. After the operation 950, the system may proceed to construct a path for another service request. When constructing the next path for the another service request, the dynamic network state may carry through. That is, the updates to the dynamic network state used to construct the previous path may also be used to construct the next path.

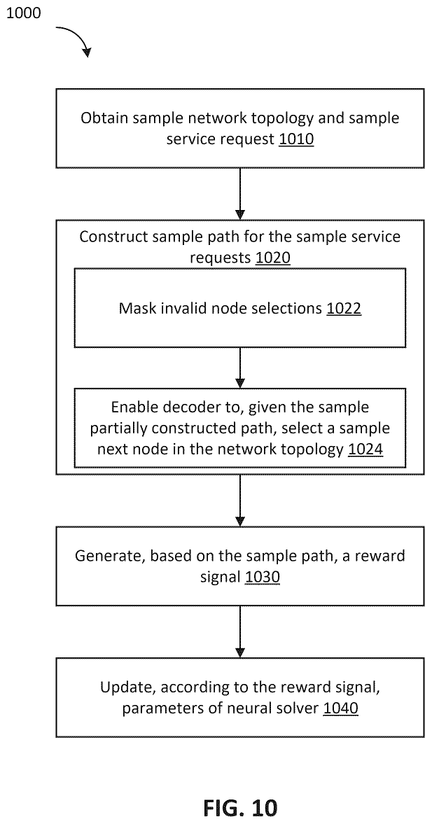

Reference is now made to FIG. 10 which illustrates, in flowchart form, a method 1000 for training, via reinforcement learning, an AI architecture for routing service requests in an optical network. The AI architecture may be the AI architecture as shown in FIGS. 2 and 3. The method 1000 may be implemented by a computing device having suitable processor-executable instructions for causing the computing device to carry out the described operations. The method 1000 may be implemented, in whole or in part, by a computing system such as the computer system 600. As setup to the method 1000, the computer system may maintain an AI architecture as discussed with reference to FIGS. 2 and 3.

The method 1000 begins with an operation 1010. At the operation 1010, the system may obtain a sample network topology and sample service requests. The sample network topology may be a network topology used to train a neural solver such as the neural solvers 340 (see FIG. 3). The sample network topology may reflect the network topology of a real optical network. Likewise, the sample service requests may be service requests that are used to train the neural solver. As discussed with reference to FIG. 3, the neural solver may include 1) an encoder neural network that comprises a graph neural network or a graph embedding neural network and 2) a decoder neural network. The sample service requests may each be associated with a sample source node in the sample network topology and a sample destination node in the network topology. The sample service requests may also be associated with sample bandwidths (perhaps in terms of ODU containers).

Following the operation 1010, the system may proceed to an operation 1020. At the operations 1020, the system/neural solver may construct sample paths in the network topology for the sample service requests. That is, the system/neural network may generate sample constructed paths for the sample service requests. The sample paths may start from respective sample source nodes and terminate at respective sample destination nodes. The construction of the sample paths may be done in an autoregressive manner as described with reference to at least FIGS. 3, 7, and 9.

The operation 1020 may further include suboperations 1022 and 1024. At the suboperation 1022, the system may mask, with respect to the sample network topology, invalid node selections. The masking may, for example, prevent the neural solver from, in an iteration of autoregressive selecting of a next node, selecting a next node that is not connected to the last node of a partially constructed path of a sample service request or selecting a next node that is already in the partially constructed path of the sample service request. At the suboperation 1024, the neural solver (more specifically the decoder neural network) may be enabled to, given the sample partially constructed path of a sample service request, select a sample next node in the network topology. The sample next node may be connected to the sample partially constructed path via a sample edge of the network topology. Further, the sample next node may not already be in the partially constructed path of a sample service request.

Following the operation 1020, the system may execute an operation 1030. At the operation 1030, the system may generate, based on the sample constructed paths, reward signals. The generated reward signals may be used to modify, without limitation, the parameters and/or weightings underlying the neural solver, the encoder neural network and/or the decoder neural network. The reward signals may be generated after simulating transmitting the data of the sample service requests along the sample constructs paths. In some embodiments, the reward signals may be generated in batch. That is, sample constructed paths may be simulated in batch to generate the reward signals. In other embodiments, the reward signals may be generated in series. That is, the sample service requests/sample constructed paths may be simulated in series.

The reward signal may be configured to 1) in response to a sample constructed path succeeding (in simulation) at reaching from a sample source node to a sample destination node, a negative value representing a measure of sample resources used in the sample network topology by establishing a corresponding sample service path (path/lightpath in sample network topology) of the sample service request from the sample source node to the sample destination node and 2) in response to the sample constructed path failing at reaching from the sample source node to the sample destination node, a fixed negative value. Examples of such reward signals include the following as described with reference to FIG. 3:

$$Reward = \{ \begin{matrix}- bwd\_ratio * num\_hops & if success \\ - 10 * num\_net \_nodes & if failure\end{matrix}$$

$$Reward = \{ \begin{matrix}- num\_hops & if success \\ - 10 * num\_net \_nodes & if failure\end{matrix}$$

It should be appreciated that the fixed negative may be “larger” or “greater” compared to the negative value representing the measure of sample resources. That is, the fixed negative value may be considered a large penalty or, alternatively, the fixed negative value may be considered a part of a large penalty for failing to reach the sample destination node. Put another way, the reward signal for failure may be a penalty with fixed negative value.

Following the operation 1030, the system may execute an operation 1040. At the operation 1040, the system may update, according to the reward signal, the underlying parameters and/or weightings of the neural solver, the encoder neural network and/or the decoder neural network. In some embodiments, gradient descent may be used to modify the parameters/weightings based on the reward signal. For example, a loss function, the reward signal, and a learning rate may be used to compute a gradient. The gradient may then be used to modify/update the parameters/weightings of the neural solver. It should be appreciated that in reinforcement learning, the training may be configured to maximize the reward signal. Accordingly, the computing of the gradient may be configured such that after modifying the parameters/weightings according to the gradient, using the neural solver on the same sample network topology and sample service request would result in a greater reward signal. That is, the pre-modification neural solver may generate a lesser reward signal than the post-modification neural solver for the same sample network topology and sample service request.

In some implementations, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some implementations, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some implementations, an apparatus may not have any processors or computer-readable storage devices or media. Rather, the apparatus may comprise any other suitable physical or virtual components for implementing the methods disclosed herein.

In some implementations, the computer-executable instructions that implement the methods disclosed herein may be one or more computer programs, one or more program products, or a combination thereof.

In some implementations, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the above-described embodiments and/or features thereof may be customized, separated, and/or combined as needed or desired. Moreover, although embodiments have been described above with reference to the accompanying drawings, those of skill in the art will appreciate that variations and modifications may be made without departing from the scope thereof as defined by the appended claims.

1. A computer-implemented method for optical network routing, the method comprising:
encoding a network topology of an optical network using an encoder neural network to encode a plurality of nodes and a plurality of edges connecting pairs of the plurality of nodes to generate a plurality of embedding vectors;
obtaining one or more service requests, each of the one or more service requests being associated with a respective source node and a respective destination node, wherein the plurality of nodes includes the respective source node and the respective destination node;
constructing, for each of the one or more service requests, a respective path in the network topology from the respective source node to the respective destination node using a decoder neural network by:
inputting the plurality of embedding vectors and the one or more service requests to the decoder neural network, and
for each of the respective paths, starting from the respective source node, iteratively and autoregressively determining a next node on the respective path based on a dynamic network state; and
instructing one or more of a plurality of optical nodes corresponding to the plurality of nodes and one or more of a plurality of links corresponding to the plurality of edges to allocate resources to establish, for each of the respective paths, corresponding service paths in the optical network.

2. The computer-implemented method of claim 1, wherein the decoder neural network is configured to generate a probability distribution over the plurality of nodes and the next node corresponds to a greatest probability in the probability distribution.

3. The computer-implemented method of claim 1, wherein:
the decoder neural network is configured to, for each of the respective paths, starting from the respective source node, iteratively and autoregressively:
generate a probability distribution for determining the next node on the respective path based on the dynamic network state; and
determine, based on the probability distribution, a sample of one or more of the plurality of nodes; and
the method further comprises constructing each of the respective paths based on the samples of the one or more of the plurality of nodes.

4. The computer-implemented method of claim 1, wherein:
one of the one or more service requests is associated with a respective bandwidth;
each of the plurality of edges is associated with a respective capacity;
the dynamic network state indicates, based at least on the respective capacities of the plurality of edges, available capacities in the network topology; and
the method further comprises, in response to autoregressively determining a next node on the respective path of the one of the one or more service requests, and prior to another iteration of the autoregressive determining, updating the dynamic network state based on the respective bandwidth.

5. The computer-implemented method of claim 4, wherein the method further comprises:
maintaining, subsequent to determining the respective path of the one of the one or more service requests, the dynamic network state; and
constructing, using the dynamic network state, the respective path of another one of the one or more service requests.

6. The computer-implemented method of claim 1, wherein:
each of the plurality of edges is associated with one or more respective wavelengths; and
the method further comprises using the decoder neural network to determine, along with the next node, an assignment of one of the one or more respective wavelengths associated with an edge connecting the next node to a previous node on the respective path.

7. The computer-implemented method of claim 1, wherein:
each of the plurality of edges is associated with a respective available spectrum; and
the method further comprises using the decoder neural network to determine, along with the next node, an assignment of a segment of the respective available spectrum associated with an edge connecting the next node to a previous node on the respective path.

8. The computer-implemented method of claim 1, wherein the method further comprises, prior to encoding the network topology, training the encoder neural network via self-supervised learning.

9. The computer-implemented method of claim 1, wherein the method further comprises training the encoder neural network and the decoder neural network via reinforcement learning, the training including:
obtaining a sample network topology and a sample service request, the sample service request being associated with a sample source node in the sample network topology and a sample destination node in the network topology;
masking, with respect to the sample network topology, invalid node selections;
enabling the decoder neural network to, given a sample partially constructed path, select a sample next node in the network topology, the sample next node being connected to the sample partially constructed path via a sample edge of the network topology and not being in the sample partially constructed path;
generating a sample constructed path based on the sample service request; and
generating, based on the sample constructed path, a reward signal.

10. The computer-implemented method of claim 9, wherein the method further comprises configuring the reward signal to be:
in response to the sample constructed path succeeding at reaching from the sample source node to the sample destination node, a negative value representing a measure of sample resources used in the sample network topology by establishing a corresponding sample service path from the sample source node to the sample destination node; and
in response to the sample constructed path failing at reaching from the sample source node to the sample destination node, a penalty with fixed negative value.

11. The computer-implemented method of claim 1, wherein the method further comprises:
detecting a network failure in the optical network; and
obtaining, in response to detecting the network condition, at least one of the one or more service requests.

12. A computer system for optical network routing, the computer system comprising:
at least one processor;
a network interface coupled to one of the at least one processor, the network interface allowing the at least one processors to monitor and interact with the optical network;
at least one memory storing instructions that, when executed the at least one processor, cause the at least one processor to:
encode a network topology of an optical network using an encoder neural network to encode a plurality of nodes and a plurality of edges connecting pairs of the plurality of nodes to generate a plurality of embedding vectors;
obtain one or more service requests, each of the one or more service requests being associated with a respective source node and a respective destination node, wherein the plurality of nodes includes the respective source node and the respective destination node;
construct, for each of the one or more service requests, a respective path in the network topology from the respective source node to the respective destination node using a decoder neural network by:
inputting the plurality of embedding vectors and the one or more service requests to the decoder neural network, and
for each of the respective paths, starting from the respective source node, iteratively and autoregressively determining a next node on the respective path based on a dynamic network state; and
instruct one or more of a plurality of optical nodes corresponding to the plurality of nodes and one or more of a plurality of links corresponding to the plurality of edges to allocate resources to establish, for each of the respective paths, corresponding service paths in the optical network.

13. The computer system of claim 12, wherein:
one of the one or more service requests is associated with a respective bandwidth;
each of the plurality of edges is associated with a respective capacity;
the dynamic network state indicates, based at least on the respective capacities of the plurality of edges, available capacities in the network topology; and
the instructions further configure the processor to, in response to autoregressively determining a next node on the respective path of the one of the one or more service requests, and prior to another iteration of the autoregressive determining, update the dynamic network state based on the respective bandwidth.

14. The computer system of claim 13, wherein the instructions further configure the at least one processor to:
maintain, subsequent to determining the respective path of the one of the one or more service requests, the dynamic network state; and
construct, using the dynamic network state, the respective path of another one of the one or more service requests.

15. The computer system of claim 12, wherein:
each of the plurality of edges is associated with one or more respective wavelengths; and
the instructions further configure the processor to use the decoder neural network to determine, along with the next node, an assignment of one of the one or more respective wavelengths associated with an edge connecting the next node to a previous node on the respective path.

16. The computer system of claim 12, wherein:
each of the plurality of edges is associated with a respective available spectrum; and
the instructions further configure the processor to use the decoder neural network to determine, along with the next node, an assignment of a segment of the respective available spectrum associated with an edge connecting the next node to a previous node on the respective path.

17. The computer system of claim 12, wherein the instructions further configure the at least one processor to train the encoder neural network and the decoder neural network via reinforcement learning, the training including:
obtaining a sample network topology and a sample service request, the sample service request being associated with a sample source node in the sample network topology and a sample destination node in the network topology;
masking, with respect to the sample network topology, invalid node selections;
enabling the decoder neural network to, given a sample partially constructed path, select a sample next node in the network topology, the sample next node being connected to the sample partially constructed path via a sample edge of the network topology and not being in the sample partially constructed path;
generating a sample constructed path based on the sample service request; and
generating, based on the sample constructed path, a reward signal.

18. The computer system of claim 17, wherein the reward signal is configured to be:
in response to the sample constructed path succeeding at reaching from the sample source node to the sample destination node, a negative value representing a measure of sample resources used in the sample network topology by establishing a corresponding sample service path from the sample source node to the sample destination node; and
in response to the sample constructed path failing at reaching from the sample source node to the sample destination node, a penalty with fixed negative value.

19. The computer system of claim 12, wherein the instructions further configure the at least one processor to:
detect a network failure in the optical network; and
obtain, in response to detecting the network condition, at least one of the one or more service requests.

20. A non-transitory computer-readable medium storing processor-executable instructions that, when executed by a processor, cause the processor to:
encode a network topology of an optical network using an encoder neural network to encode a plurality of nodes and a plurality of edges connecting pairs of the plurality of nodes to generate a plurality of embedding vectors;
obtain one or more service requests, each of the one or more service requests being associated with a respective source node and a respective destination node, wherein the plurality of nodes includes the respective source node and the respective destination node;
construct, for each of the one or more service requests, a respective path in the network topology from the respective source node to the respective destination node using a decoder neural network by:
inputting the plurality of embedding vectors and the one or more service requests to the decoder neural network, and
for each of the respective paths, starting from the respective source node, iteratively and autoregressively determining a next node on the respective path based on a dynamic network state; and
instruct one or more of a plurality of optical nodes corresponding to the plurality of nodes and one or more of a plurality of links corresponding to the plurality of edges to allocate resources to establish, for each of the respective paths, corresponding service paths in the optical network.
